(19) United States
(12) Patent Application Publication
(10) Pub. No.: US 2021/0337073 A1
(43) Pub. Date: Oct. 28, 2021

(54) PRINT QUALITY ASSESSMENTS VIA PATCH CLASSIFICATION

(71) Applicant: Hewlett-Packard Development Company, L.P., Spring, TX (US)

(72) Inventors: Qian Lin, Palo Alto, CA (US); Otavio Basso Gomes, Porto Alegre (BR); Augusto Cavalcante Valente, Campinas (BR); Guilherme Augusto Silva Megeto, Porto Alegre (BR); Marcos Henrique Cascone, Porto Alegre (BR); Thomas da Silva Paula, Porto Alegre (BR); Fabio Vinicius Moreira Perez, Campinas (BR)

(73) Assignee: Hewlett-Packard Development Company, L.P., Spring, TX (US)

(21) Appl. No.: 17/284,110

(22) PCT Filed: Dec. 20, 2018
(86) PCT No.: PCT/US2018/066984

§ 371 Date: Apr. 9, 2021

(51) Int. Cl. H04N 1/00; G06K 9/03; G06K 9/46

(52) U.S. Cl. CPC H04N 1/00045; G06K 9/4604; G06K 9/03

(57) ABSTRACT

An example of an apparatus is provided. The apparatus includes an extraction engine to extract a plurality of patches from an image of a printed document. The apparatus further includes a classification engine to analyze each patch of the plurality of patches and to assign a defect probability to each patch of the plurality of patches. The apparatus also includes a rendering engine to generate a map based on the defect probability of each patch of the plurality of patches. The map is to identify defects in the printed document.

### BACKGROUND

A printing device may generate prints during operation. In some cases, the printing device may introduce defects into the printed document which are not present in the input image. The defects may include streaks or bands that appear on the printed document. The defects may be an indication of a hardware failure or a direct result of the hardware failure. In some cases, the defects may be identified with a side by side comparison of the intended image (i.e. a reference print) with the printed document generated from the image file.

### BRIEF DESCRIPTION OF THE DRAWINGS

Reference will now be made, by way of example only, to the accompanying drawings in which:

FIG. 1 is a block diagram of an example apparatus to assess a print quality of a printed document by analyzing an image;

FIG. 2 is a block diagram of another example apparatus to assess a print quality of a printed document by analyzing an image;

FIG. 3 is a block diagram of an example system to assess a print quality of a printed document from analyzing an image;

FIG. 4 is a block diagram of another example apparatus to assess a print quality of a printed document by analyzing an image; and

FIG. 5 is a flowchart of an example method of assessing a print quality of a printed document by analyzing an image.

### DETAILED DESCRIPTION

Although there may be a trend to paperless technology in applications where printed media has been the standard, such as electronically stored documents in a business, printed documents are still widely accepted and may often be more convenient to use. In particular, printed documents are easy to distribute, store, and be used as a medium for disseminating information. In addition, printed documents may serve as contingency for electronically stored documents, such as may happen when an electronic device fails, such as with a poor data connection for downloading the document and/or a depleted power source. Accordingly, the quality of printed documents is to be assessed to maintain the integrity of the information presented in the printed document as well as to maintain aesthetic appearances.

For example, printing devices may generate artifacts that degrade the quality of printed documents. These artifacts may occur, for example, due to defective toner cartridges and general hardware malfunction. In general, numerous test pages are printed to check for defects both during manufacturing and while a printing device is in use over the life of the printing device. Visually inspecting each printed document by a user may be tedious, time consuming, and error prone. This disclosure includes examples that provide an automated method to segment multiple types of artifacts in printed pages, without using defect-free images for comparison purposes.

An apparatus to carry out automated computer vision-based method to detect and locate printing defects in scanned images is provided. In particular, the apparatus carries out the method without comparing a printed document against a reference source image to reduce the amount of resources used to make such a comparison. It is to be appreciated by a person of skill in the art that by omitting the comparison with a reference source image, the method used by the apparatus reduces the resources that are to be used to integrate a reference comparison process into a printing workflow. As an example, the apparatus may be used to detect color banding and dark streaks on printed documents using a convolutional neural network model. Since high resolution images may be captured of a printed document, the raw image may be too large for a deep convolutional neural network model application using commonly available computer resources. Accordingly, the images may be divided into a plurality of patches, where each patch may be analyzed to determine a defect probability for the patch. The results of the analysis on each patch may subsequently be combined to form a map of patches and the determined defect probability for the patch. The map is not particularly limited and may be presented as a three-dimensional contour map or a heat map to aid in the identification of defects on the image.

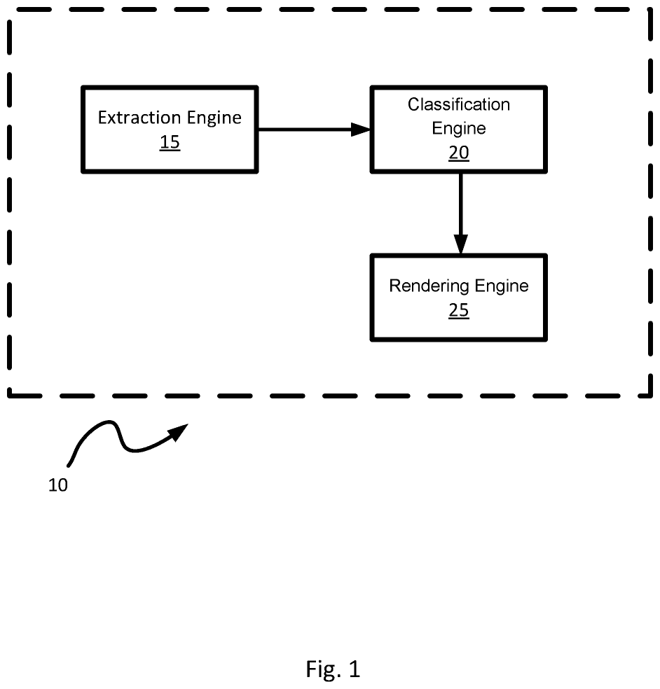

Referring to FIG. 1, an example of an apparatus to assess the print quality of a printed document is generally shown at 10. The apparatus 10 may include additional components, such as various memory storage units, interfaces to communicate with other devices, and further input and output devices to interact with a user or an administrator of the apparatus 10. In addition, input and output peripherals may be used to train or configure the apparatus 10 as described in greater detail below. In the present example, the apparatus 10 includes an extraction engine 15, a classification engine 20, and a rendering engine 25. Although the present example shows the extraction engine 15, the classification engine 20, and the rendering engine 25 as separate components, in other examples, the extraction engine 15, the classification engine 20, and the rendering engine 25 may be part of the same physical component such as a microprocessor configured to carry out multiple functions.

In the present example, the extraction engine 15 is to extract a plurality of patches from an image of a printed document. The image of a printed document to be tested using the print quality assessment procedure described in greater detail below is not particularly limited and may be received by the apparatus 10 in a wide variety of formats. For example, the resolution of the image is not limited and may be any high-resolution image obtained from an image capture device, such as a scanner or camera. As an example, the image of the printed document may be an image with a resolution of 1980×1080 pixels, 3840×2160 pixels, or 7680×4320 pixels.

The extraction engine 15 may then divide the image of the printed document into a plurality of patches. In the present example, each patch may include a portion of the image of the printed document having a predetermined size. The size of each patch is not particularly limited and may be set according to the hardware limitations of the apparatus such that the patches may be processed in a reasonable amount of time. In the present example, the patches may be equal in size (i.e. uniformly sized) and may have a predetermined length and width, such as 64×64 pixels. The patches may then be uniformly distributed in a grid over the image of the printed document.

It is to be appreciated that in other examples, the patches may not be uniformly sized and may have a variable size. The patches may also be dependent on other factors such as the complexity of the patch. For example, if a patch includes pixels of substantially the same color and brightness, the patch may be processed in less time than a patch having complex changes in the color and brightness of the pixels. Therefore, in this alternative example, the patch size may be determined based on an estimated processing time such that each patch will be processed in approximately the same amount of time.

In the present example, each patch contains a portion of the image of the printed document. Accordingly, the whole image may be divided into a plurality of patches, where the number of patches is dependent on the resolution of the image of the printed document in the present example where each patch is 64×64 pixels. In this regard, the patches may be generated by applying a sliding window having 64×64 pixels over portions of the image. During the generation of the patches, the window may be displaced by a stride distance after the generation of each patch, so that each subsequent patch is translated by the stride distance from the previous patch. In the present example, the stride distance is greater than the predetermined width of the patch so that the patches may leave gaps and not cover the entire image. In other examples, the stride distance may be set at the same as the predetermined width to cover the entire original image. In other examples, the stride distance may be smaller than the patch size such that the patches overlap.

The classification engine 20 is to analyze the patches of the image of the printed document. In particular, the classification engine is to assign a defect probability to each patch of the image. The manner by which the defect probability for each patch is assigned is not particularly limited. For example, the classification engine 20 may carry out a machine learning process such as a deep learning technique using convolutional neural networks. In particular, the classification engine 20 may use a publicly available convolution neural network. In other examples, the classification engine 20 may train a convolutional neural network for use on the patches. In other examples, the classification engine 20 may use a rules-based prediction method to analyze the image of the printed document. In other examples, machine learning models may be used to predict and/or classify a specific type of defect as well as assign a defect probability. For example, the machine learning models may be a neural network, such as a convolutional neural network, a recurrent neural network, or another classifier model such as support vector machines, random forest trees, Naïve Bayes classifiers, or any combination of these models along with additional models

In the present example, the classification engine 20 applies a convolutional neural network to the patent to determine a defect probability for the patch. For example, the classification engine 20 may analyze the pixels within a patch to determine that a defect, such as a streak-type defect, is likely to be present in the patch. A streak-type defect may be characterized by a decrease in the intensity of a channel in the Red-Green-Blue (RGB) colorspace to generate a darker line during the printing process. The classification engine 20 may then subsequently carry our further analysis using another model to determine the certainty, such as a probability, that the defect is present in the patch. The defect probability is to be assigned to the patch for subsequent analysis of the image as a whole. It is to be appreciated that the type of defect is not particularly limited and the classification engine 20 may be used to identify and analyze other types of defects. As another example of a defect, the classification engine 20 may identify a defect as a band-type defect, which is characterized by a rectangular disturbance in one of the channels in the Cyan-Magenta-Yellow-Key (CMYK) colorspace.

It is to be appreciated by a person of skill in the art that by applying the classification engine 20 to a patch instead of the image as a whole, computational resources are conserved. In this regard, the classification engine 20 may analyze an entire image faster by analyzing individual patches when compared to analyzing the entire image at once.

In the present example, the rendering engine 25 is to generate a map based on the defect probability of the patches of the image of the printed document. The map is not particularly limited and may be used to readily identify a defect in the printed document that is to be addressed using a post processing process. For example, the map may be a heat map where various shading and/or color schemes are used to indicate a defect probability at locations across the image. In other examples, a three-dimensional map may be generated where elevation may be used to indicate the defect probability at locations across the image of the printed document. The post processing of the map is not particularly limited. In the present example, the map may be provided to another service for processing or may be displayed on a screen for a user to analyze. In other examples, a post processing engine may be used to identify defects in the printed document.

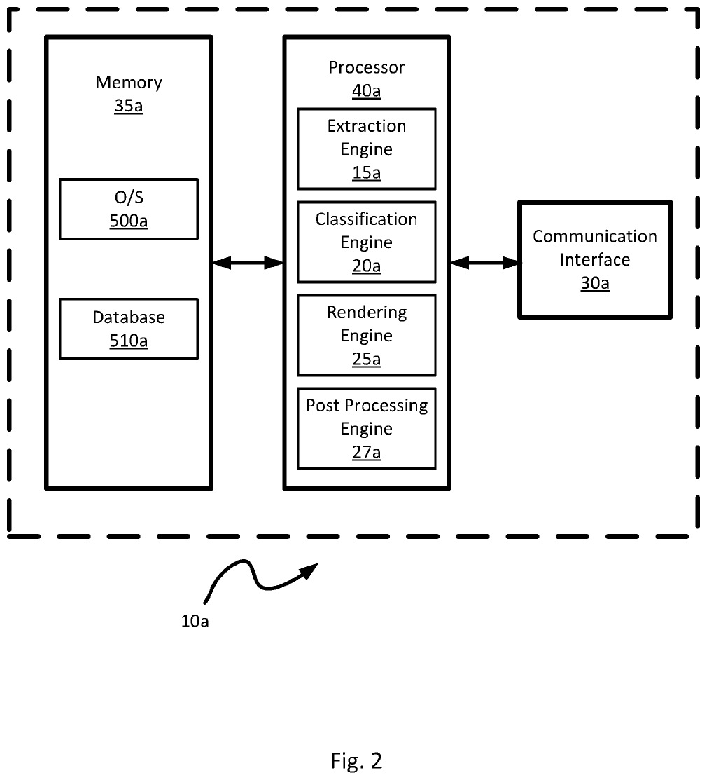

Referring to FIG. 2, another example of an apparatus to assess the print quality of a printed document is shown at 10a. Like components of the apparatus 10a bear like reference to their counterparts in the apparatus 10, except followed by the suffix “a”. The apparatus 10a includes a communication interface 30a, a memory storage unit 35a, and a processor 40a. In the present example, an extraction engine 15a, a classification engine 20a, a rendering engine 25a, and a post processing engine 27a are implemented by the processor 40a.

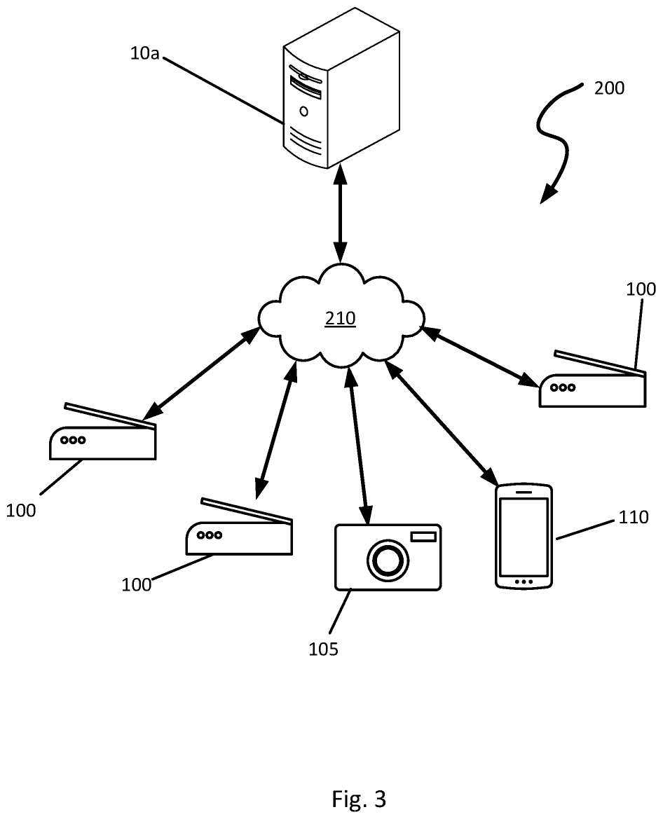

Referring to FIG. 3, the communications interface 30a is to communicate with external devices over the network 210, such as scanners 100, cameras 105, and smartphones 110. Accordingly, the communications interface 30a may be to receive the image of the printed document from an external device, such as a scanner 100, a camera 105, or a smartphone 110. The manner by which the communications interface 30a receives the image of the printed document is not particularly limited. In the present example, the apparatus 10a may be a cloud server located at a distant location from the device, such as scanners 100, cameras 105, and smartphones 110, which may each be broadly distributed over a large geographic area. Accordingly, the communications interface 30a may be a network interface communicating over the Internet. In other examples, the communication interface 30a may connect to the external devices via a peer to peer connection, such as over a wire or private network. It is to be appreciated that in this example, the apparatus 10a may carry out assessments for multiple devices and offer the assessment as a service. In other examples, the apparatus 10a may be part of a device management system capable of assessing printing devices for issues at several locations with managed devices.

The memory storage unit 35a is to store the image of the printed document as well as processed data, such as data associated with the generation of the patches and the results of the analysis of the patches. Accordingly, in the present example, the memory storage unit 35a may be connected to the communication interface 30a to receive the image of the printed document from the external device via the network 210. In addition, the memory storage unit 35a is to maintain a database 510a to store a training dataset. The manner by which the memory storage unit 35a stores or maintains the database 510a is not particularly limited. In the present example, the memory storage unit 35a may maintain a table in the database 510a to store and index the training dataset received by the communication interface 30a. For example, the training dataset may include samples of test images with synthetic artifacts injected into the test images. The test images in the training dataset may then be used to train the model used by the classification engine 20a.

As an example, the database 510a may include 50 test images to be used for the training set. The test images are not limited and may be obtained from various sources. In the present example, the test images are generated using simulated streaks that were printed to a document and re-scanned. From each image, 640 random patches may be extracted per training epoch. Continuing with the present example, the model may be trained for forty epochs resulting in 1.28 million unique patches to be used for training. It is to be appreciated that the training dataset is not particularly limited and that more or fewer test images may be used. In addition, the number of patches as well as the number of training epochs may be varied.

Continuing with this training example, a convolutional neural network model based on a ResNet-50 architecture pre-trained on ImageNet with the last two layers modified to print defect classification task may be used. The convolutional neural network may be trained using an Adam optimizer with a learning rate of 0.00001 and weight decay of 0.0001. In this example, the training process may be two hours on a typical server. It is to be appreciated that the time may be very dependent on the hardware characteristics of the server. It is to be appreciated that this training method may be used to detect different types of additional printing defects via re-training the convolutional neural network.

The memory storage unit 35a components is not particularly limited. For example, the memory storage unit 35a may include a non-transitory machine-readable storage medium that may be, for example, an electronic, magnetic, optical, or other physical storage device. In addition, the memory storage unit 35a may store an operating system 500a that is executable by the processor 40a to provide general functionality to the apparatus 10a. For example, the operating system may provide functionality to additional applications. Examples of operating systems include Windows™, macOS™, iOS™, Android™, Linux™, and Unix™. The memory storage unit 30a may additionally store instructions to operate at the driver level as well as other hardware drivers to communicate with other components and peripheral devices of the apparatus 10a.

The processor 40a may include a central processing unit (CPU), a graphics processing unit (GPU), a microcontroller, a microprocessor, a processing core, a field-programmable gate array (FPGA), an application-specific integrated circuit (ASIC), or similar. In the present example, the processor 40a and the memory storage unit 35a may cooperate to execute various instructions. The processor 40a may execute instructions stored on the memory storage unit 35a to carry out processes such as to assess the print quality of a received scanned image of the printed document. In other examples, the processor 40a may execute instructions stored on the memory storage unit 35a to implement the extraction engine 15a, the classification engine 20a, the rendering engine 25a, and the post processing engine 27a. In other examples, the extraction engine 15a, the classification engine 20a, the rendering engine 25a, and the post processing engine 27a may each be executed on a separate processor (not shown). In further examples, the extraction engine 15a, the classification engine 20a, the rendering engine 25a, and the post processing engine 27a may each be executed on a separate machine, such as from a software as a service provider or in a virtual cloud server.

The post processing engine 27a is to identify defects in the printed document based on the map generated by the rendering engine 25a. The manner by which the post processing engine 27a identifies defects is not limited. In the present example, the post processing engine 27a receives the map from the rendering engine 25a and may clean up any noise output in the patches using various image processing techniques. In the present example, the post processing engine 27a detects candidate regions of defects using a thresholding method to create a binary classification between a defect patch and a non-defect patch. In the present example, a value of a threshold may be calculated based on the mean and standard deviation of the defect probabilities assigned to the patches in the map by the classification engine 20a. The post processing engine 27a may connect regions of patches from the map identified as defect regions. The manner by which the regions are connected is not limited. For example, patches may be connected to form a region if patches adjacent to each other are determined by the classification engine 20a to include a defect probability above the threshold. As another example, patches may be connected to form a region if patches within a predetermined distance to each other are determined by the classification engine 20a to include a defect probability above the threshold. If the defect region is smaller than a predetermined size, it is considered noise. Alternatively, if a defect region is larger than the predetermined size, the image of the printed document as a whole may be labeled as a defective image, whereas an image without a defect region larger than the predetermined size may be labeled as a non-defective image.

It is to be appreciated that additional functions may also be carried out by the post processing engine 27a. For example, the post processing engine 27a may further analyze the defective image to determine the type and cause of the defect in the printed document. Accordingly, once the type and/or cause of a print defect is determined, a solution may be implemented by a user or via another automated process carried out by the apparatus 10a. By further classifying a defect in a printed document that is generated by a printing device, subsequent diagnosis of the issue causing the defect may be facilitated. By increasing the accuracy and objectivity of a diagnosis of a potential issue, a solution may be more readily implemented which may result in an increase in operational efficiency and a reduction on the downtime of a printing device.

Referring to FIG. 3, an example of a print quality assessment system to monitor prints generated by a printing device generally shown at 200. In the present example, the apparatus 10a is in communication with scanners 100, a camera 105, and a smartphone 110 via a network 210. It is to be appreciated that the scanners 100, the camera 105, and the smartphone 110 are not limited and additional devices capable of capturing an image may be added.

It is to be appreciated that in the system 200, the apparatus 10a may be a server centrally located. The apparatus 10a may be connected to remote devices such as scanners 100, cameras 105, and smartphones 110 to provide print quality assessments to remote locations. For example, the apparatus 10a may be located at a corporate headquarters or at a company providing a device as a service offering to clients at various locations. Users or administrators at each location periodically submit a scanned image of a printed document generated by a local printing device to determine whether the local printing device is performing within specifications and/or whether the local printing device is to be serviced.

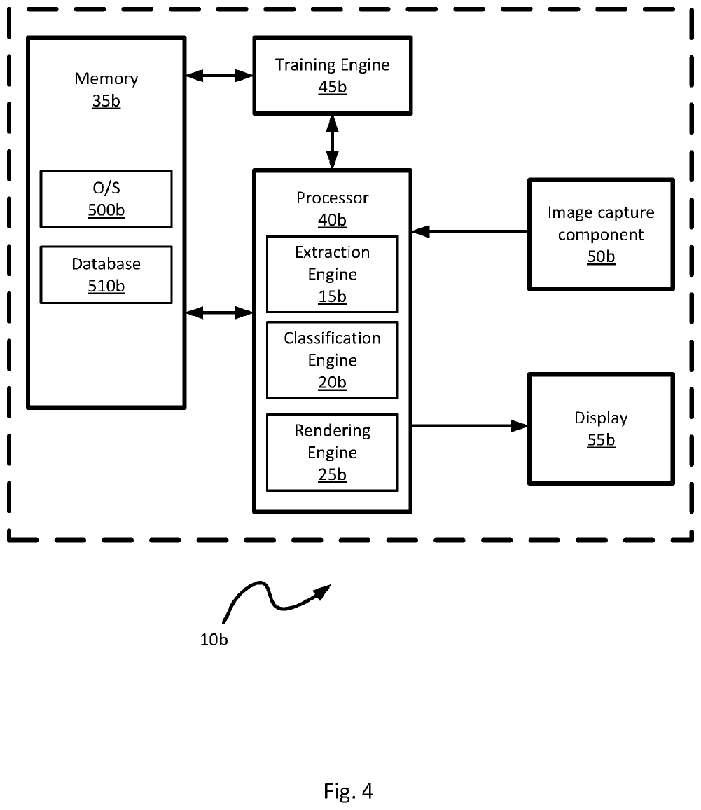

Referring to FIG. 4, another example of an apparatus to assess the print quality of a printed document is shown at 10b. Like components of the apparatus 10b bear like reference to their counterparts in the apparatus 10 and the apparatus 10a, except followed by the suffix “b”. In the present example, the apparatus 10b includes a memory storage unit 35b, a processor 40b, a training engine 45b, an image capture component 50b, and a display 55b. In the present example, an extraction engine 15b, a classification engine 20b, and a rendering engine 25b are implemented by processor 40b.

The memory storage unit 35b is to store data used by the processor 40b during normal operation. For example, the memory storage unit 35b may be used to store the image of the printed document as well as intermediate data, such as information associated with the patches generated by the extraction engine 15b. In addition, the memory storage unit 35b is to maintain a database 510b to store a training dataset. In addition, the memory storage unit 35b may store an operating system 500b that is executable by the processor 40b to provide general functionality to the apparatus 10b.

The training engine 45b is to train a model used by the classification engine 20b. For example, the classification engine 20b may use a convolutional neural network to assign the defect probability for a patch. The manner by which the training engine 45b trains the convolutional neural network model used by the classification engine 20b is not limited. In the present example, the training engine 45b may use training images stored in the database 510b to train the convolutional neural network model. In the present example, images in the database, may be modified to introduce defects. The manner by which a defect is introduced is not particularly limited. For example, common data augmentation techniques may be applied to the training images to increase their variability and increase the robustness of the convolutional neural network to different types of input sources. For example, adding different levels of blur may help the convolutional neural network handle lower resolution images of the printed document. Another example is adding different amounts and types of statistical noise, which may help the network handle noisy input sources. In addition, horizontal flipping may substantially double the number of training examples. It is to be appreciated that various combinations of these techniques may be applied, resulting in a training set many times larger than the original number of images.

The image capture component 50b is to capture an image of a printed document generated by a printing device. In particular, the image capture component 50b is to capture the complete image of the printed document for analysis. The manner by which the image is captured using the image capture component 50b is not limited. For example, the image capture component 50b may be a flatbed scanner, a camera, a tablet device, or a smartphone.

The display 55b is to output the map generated by the rendering engine 25b. For example, the display may output the map over the complete image captured by the image capture component 50b. For example, the rendering engine 25b may generate an augmented image to superimpose pixels that have been identified as defective. Accordingly, it is to be appreciated that the apparatus 10b provides a single device that may be used to assess the quality of a printed document. In particular, since the apparatus 10b includes an image capture component 50b and a display 55b, it may allow for rapid local assessments of print quality.

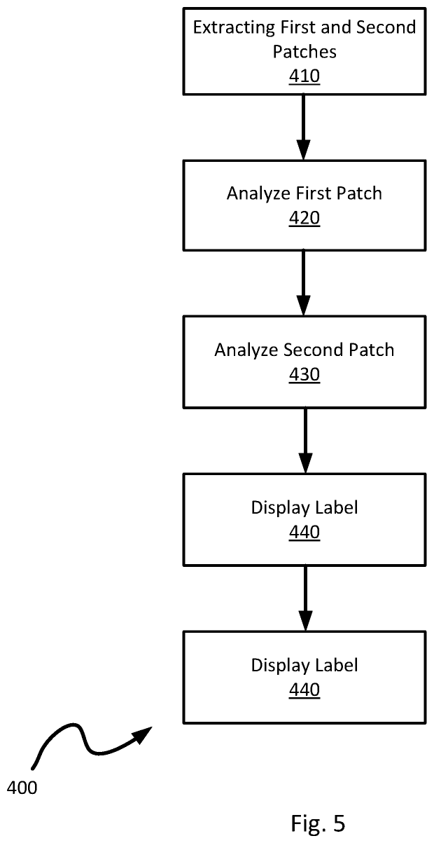

Referring to FIG. 5, a flowchart of an example method of print quality assessments is generally shown at 400. In order to assist in the explanation of method 400, it will be assumed that method 400 may be performed with the system 200. Indeed, the method 400 may be one way in which system 200 along with an apparatus 10, 10a, or 10b may be used. Furthermore, the following discussion of method 400 may lead to a further understanding of the system 200 and the apparatus 10, 10a, or 10b. In addition, it is to be emphasized, that method 400 may not be performed in the exact sequence as shown, and various blocks may be performed in parallel rather than in sequence, or in a different sequence altogether.

Beginning at block 410, a plurality of patches is to be extracted from an image of a printed document. The manner by which the patches are extracted is not particularly limited. For example, the extraction engine 15 may divide the image of the printed document into a plurality of patches in accordance with a predetermined process. In the present example, each patch may include a portion of the image of the printed document having a predetermined size. The size of each patch is not particularly limited and may be set according to the hardware limitations of the apparatus such that the patches may be processed in a reasonable amount of time. In the present example, the patches may be equal in size (i.e. uniformly sized) and may have a predetermined length and width, such as 64×64 pixels. The patches may then be uniformly distributed in a grid over the image of the printed document.

Block 420 analyzes a patch to determine a defect probability associated with the patch. The manner by which the defect probability is determined is not particularly limited. For example, the classification engine 20 may carry out a machine learning process such as a deep learning technique using convolutional neural networks. In particular, the classification engine 20 may use a publicly available convolution neural network. In other examples, the classification engine 20 may train a convolutional neural network for use on the patches. In further examples, the classification engine 20 may use a rules-based prediction method to analyze the image of the printed document.

Block 430 analyzes another patch to determine a defect probability associated with the patch. The manner by which the defect probability is determined is not particularly limited and may involve a process describe above in connection with block 420. Furthermore, it is to be appreciated that the execution of block 430 may be independent of the execution of block 420. In particular, blocks 420 and 430 may apply the same model to determine the defect probability for each patch separately. In some examples, block 420 and 430 may apply different models to their respective patches.

Block 440 involves generating a map based on the defect probabilities determined in blocks 420 and block 430. It is to be appreciated that the manner by which the map is not generated is not particularly limited. A heat map may be generated where various shading and/or color schemes are used to indicate defect probabilities determined in blocks 420 and block 430. In other examples, a three-dimensional map may be generated where elevation may be used to indicate the defect probability at locations of the patches associated with blocks 420 and block 430. The three-dimensional map may also be superimposed or displayed over the image of the printed document to provide an intuitive user interface, where closer inspection of a portion of the printed document may be carried out by a user after the identification of a defect region. It is to be appreciated that other manners of presenting the map may be provided. For example, the map may be provided to block 450 in a raw data format, such as a table of values.

Block 450 identifies a defect in the printed document based on the map. In the present example, a predetermined threshold may be used to identify the defect. For example, an image of a printed document may be considered to have a defect if a single patch is determined to have a defect probability above the predetermined threshold value. In other examples, an image of a printed document may be considered to have a defect if a number of patches are determined to have a defect probability above the predetermined threshold value. In this example, the number is not particularly limited and may be a fixed number or may be variable depending on a statistical variation of the defect probabilities among all patches.

Various advantages will now become apparent to a person of skill in the art. For example, the system 200 may provide an objective manner for print quality assessments to aid in the identification of defects at a printing device without using a reference document. Furthermore, the method may also identify issues with print quality before a human eye is able to make such a determination. In particular, this will increase the accuracy of the analysis leading to increased overall print quality from printing devices.

It should be recognized that features and aspects of the various examples provided above may be combined into further examples that also fall within the scope of the present disclosure.

What is claimed is:

1. An apparatus comprising:
an extraction engine to extract a plurality of patches from an image of a printed document;
a classification engine to analyze each patch of the plurality of patches and to assign a defect probability to each patch of the plurality of patches; and
a rendering engine to generate a map based on the defect probability of each patch of the plurality of patches, wherein the map is to identify defects in the printed document.

2. The apparatus of claim 1, further comprising a communication interface to receive the image of the printed document from an external device.

3. The apparatus of claim 2, further comprising a memory storage unit connected to the communication interface, the memory storage unit to store the image of the printed document.

4. The apparatus of claim 1, wherein each patch of the plurality of patches is equal in size, each patch with a predetermined width.

5. The apparatus of claim 4, wherein a first patch selected from the plurality of patches and a second patch selected from the plurality of patches are separated by a stride distance, the first patch to be adjacent the second patch.

6. The apparatus of claim 5, wherein the stride distance is greater than the predetermined width.

7. The apparatus of claim 1, wherein the plurality of patches is to be uniformly distributed in a grid over the image of the printed document.

8. The apparatus of claim 1, wherein the classification engine is to use a convolutional neural network to analyze each the plurality of patches.

9. The apparatus of claim 1, further comprising a post processing engine to identify defects in the printed document based on the map.

10. A method comprising:
extracting a first patch and a second patch from an image of a printed document;
analyzing the first patch to determine a first defect probability associated with the first patch;
analyzing the second patch to determine a second defect probability associated with the second patch;
generating a map based on the first defect probability and the second defect probability; and
identifying a defect in the printed document based on the map.

11. The method of claim 10, wherein identifying the defect comprises determining if the first defect probability is above a predetermined threshold.

12. The method of claim 10, wherein analyzing the first patch and analyzing the second patch involves a convolutional neural network, wherein the convolutional neural network is to be applied to the first patch and the second patch separately.

13. The method of claim 10, further comprising displaying the first patch and the second patch on the map of the image of the printed document.

14. A non-transitory machine-readable storage medium encoded with instructions executable by a processor, the non-transitory machine-readable storage medium comprising:
instructions to extract a plurality of patches from an image of a printed document;
instructions to analyze each patch of the plurality of patches and to assign a defect probability to each patch of the plurality of patches;
instructions to generate a map based on the defect probability of each patch of the plurality of patches; and
instructions to identify defects in the printed document based on the map.

15. The non-transitory machine-readable storage medium of claim 14, further comprising instructions to distribute the plurality of patches uniformly in a grid over the image of the printed document.
